(19) United States
(12) Patent Application Publication
(10) Pub. No.: US 2010/0283212 A1
(43) Pub. Date: Nov. 11, 2010

(54) SEAL PACK WITH WASHER SEPARATOR

(75) Inventors: Marion Jack Ince, Mount Holly, NC (US); Charles M. Schwab, Fort Mill, SC (US)

Correspondence Address: LUCAS & MERCANTI, LLP, 475 Park Avenue South, New York, NY, 10016, US

(73) Assignee: SCHAEFFLER TECHNOLOGIES GMBH & CO. KG, Herzogenaurach (DE)

(21) Appl. No.: 12/774,216

(22) Filed: May 5, 2010

Related U.S. Application Data
(60) Provisional application No. 61/175,974, filed on May 6, 2009.

(51) Int. Cl. F16J 15/54; F16L 27/087

(52) U.S. Cl. 277/500

(57) ABSTRACT

A seal pack, including a cylindrical ring having peripheral edges with radially extending flanges that have axially facing surfaces. A respective sealing ring is arranged on each of the axially facing surfaces of the flanges of the cylindrical ring so as to form a channel between the sealing rings. A wave washer is arranged between sealing rings so as to retain the sealing rings in a position so as to allow for sealing against the flanges.

### BACKGROUND OF THE INVENTION

The present invention relates to a seal pack for sealing the space between a rotating component and a stationary component. More particularly, the invention relates to a seal pack for directing or channeling the flow of lubricant between the rotating component and the stationary component.

An example of usage of such a seal pack would be to direct the flow of lubricant from a stationary automotive automatic transmission shaft through the seal pack and into a rotating housing for actuating a multi-plate wet clutch, or allowing for continuous lubricant flow.

When dealing with a rotating shaft, the rotating shaft has a fluid flow exit port. The fluid leaving the exit port must be directed into a stationary port in the housing in which the shaft rotates. This directed flow is achieved by a channel with sealing rings at the outer periphery, thus creating a seal between the shaft and the housing. Lubricant flow, under pressure, exits the rotating shaft port, flows around the sealed channel and enters the stationary port in the housing.

Conventionally, in an application as mentioned above, fluid flow was directed by cutting a groove in the shaft to create a channel and arrange sealing rings at the outer peripherals to thereby create a seal between the shaft and the housing. The problem with this type of construction is that the groove results in a weakened shaft, especially with thin radial cross-sections. In addition, some applications utilize a shaft that is prone to wear by the sealing rings, i.e. aluminum.

Another prior art solution involved arranging a flanged inner ring on the shaft. The inner ring is mounted so that an opening on the inner ring was oriented at the shaft exit port. Sealing rings are arranged on the inner ring to create a seal between the shaft/inner ring and the housing. Since the sealing rings must be located at a distance apart from one another to create a channel, there is the problem of maintaining the sealing rings at this distance. In the prior art this was accomplished using a profiled inner ring. However, such inner rings are expensive and complex to manufacture. Another prior art solution was to use a profiled spacer to separate the sealing rings. Such a profiled spacer required expensive manufacturing tooling for production, thus making the solution undesirable.

One example of prior art sealing is found in U.S. Pat. No. 3,917,288, which discloses a packing seal in which peripheral grooves are provided in the shaft and then seals are arranged in the grooves.

Complex shaft seals are known which do not require grooves to be formed in the shaft. Examples of such seals can be found in U.S. Pat. Nos. 4,381,867; 4,522,410; 3,441,284; and 5,409,240. As previously indicated, the problem with these seals is their extremely complex construction which makes them very expensive to manufacture and, due to the sheer number of parts in some of the seals, makes them more susceptible to failure.

Since the sealing rings must be located a distance apart from one another to create the channel, this can be accomplished using a profiled inner ring that has a ridge so that the sealing rings are nested between the flange and the ridge on each axial end of the inner ring, thereby creating the sealing ring separation.

Another alternative is to use a flanged inner ring with a profiled spacer to separate the sealing rings. This also involves expensive manufacturing tooling to produce such a profiled spacer. Examples of such constructions can be found in U.S. Pat. Nos. 3,767,212; and 2,402,033.

U.S. Pat. No. 6,224,063 utilizes an intermediate member arranged between the housing and the shaft. The intermediate member has grooves into which annular seal rings fit so as to maintain the seal rings in a defined spacing.

### SUMMARY OF THE INVENTION

Accordingly, it is an object of the present invention to provide a seal pack that has a simple construction and is inexpensive to manufacture.

Pursuant to this object, and others which will become more apparent hereafter, one aspect of the present invention resides in the seal pack having a cylindrical ring with peripheral edges from which flanges extend radially. A sealing ring is arranged against each flange so that a channel is formed between the sealing rings and the surface of the cylindrical ring. A wave washer is arranged between the sealing rings so as to maintain the rings in a position so as to allow for sealing against the flanges.

In this way, the sealing rings can be held in position in an inexpensive manner even when there is no pressure being generated from the lubricant in the channel against the inner surface of the rings.

Other features and advantages of the present invention will become apparent from the following description of the invention that refers to the accompanying drawings.

### BRIEF DESCRIPTION OF THE DRAWINGS

FIG. 1 is a perspective view of the assembled seal pack;

FIG. 2 is a perspective view of the support ring;

FIG. 3 is a perspective view of a sealing ring;

FIG. 4 is an elevational view of wave washer;

FIG. 4a is a section along the line A-A in FIG. 4; and

FIG. 5 is a side view of the washer of FIG. 4.

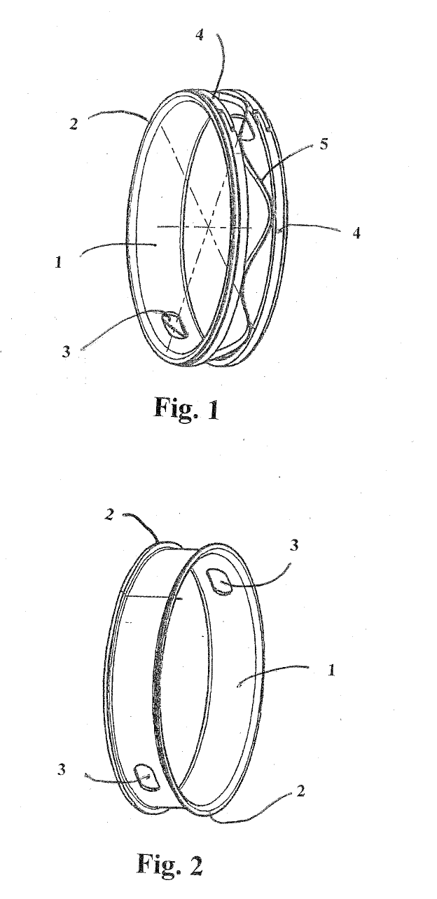

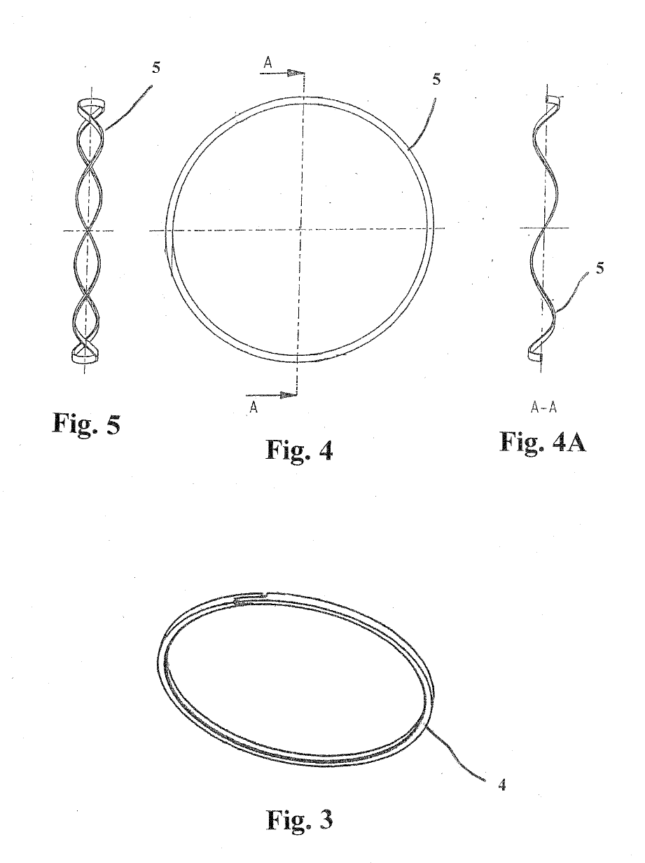

### DETAILED DESCRIPTION OF THE INVENTION

As can be seen in the drawings, the invention has a cylindrical support ring 1 with annular flanges 2 that extend radially from the outer surface of the support ring 1.

During use, the support ring 1 is mounted on a shaft so that an opening 3 in the support ring 1 is arranged at a corresponding lubricant exit port in the shaft.

A sealing ring 4 is arranged against the inner surface of each of the flanges 2 so as to create a channel.

A wave washer 5 is arranged between two sealing rings 4 so as to locate the sealing rings 4 on either side of the ring opening 3 at the exit port. The wave washer 5 serves to hold the sealing rings 4 in a proper spacing and position so that the sealing rings 4 can be pressurized when lubricant flows from the exit port through the channel. The pressurization within the channel creates an outward force that pushes the sealing rings 4 to seal axially against the ring flanges 2, and also results in the sealing rings 4 providing a radial seal. During pressurization, the wave washer 5 may or may not contact the sealing rings 4.

Even though the wave washer 5 is arranged in the channel, due to its construction, the lubricant is permitted to flow from the exit port of the shaft, through the opening 3 in the support ring 1, around the channel created by the sealing rings 4 and then into the stationary housing in which the shaft is mounted.

Although the described embodiment relates to mounting the support ring on a shaft as an outer ring, it is equally possible to reverse the construction so that the support ring is mounted to the housing as an inner ring, whereby the sealing rings create a seal between the shaft and the support ring. The seal pack of the present invention has many applications, including use in a rotating housing and a stationary shaft, a counter-rotating shaft and a housing, or a non-rotating shaft and a housing. Furthermore, although the invention was described in connection with lubricant, it is understood that it can be used in any fluid flow scenario.

Although the present invention has been described in relation to particular embodiments thereof, many of the variations and modifications and other uses will become apparent to those skilled in the art. It is preferred, therefore, that the invention be limited not by the specific disclosure herein but only by the appended claims.

1. A seal pack, comprising:
a cylindrical ring having peripheral edges with radially extending flanges that have axially facing surfaces;
a respective sealing ring arranged on each of the axially facing surfaces of the flanges of the cylindrical ring so as to form a channel between the sealing rings; and
a wave washer arranged between the sealing rings so as to retain the sealing rings in a position so as to allow for sealing against the flanges.

2. The seal pack according to claim 1, wherein the cylindrical ring has at least one opening in a surface between the flanges.

3. The seal pack according to claim 1, wherein the cylindrical ring is an outer ring mountable to a shaft, the flanges extending radially outward.

4. The seal pack according to claim 1, wherein the cylindrical ring is an inner ring mountable into a housing, the flanges extending radially inward.
